(19) United States
(12) Patent Application Publication
(10) Pub. No.: US 2021/0313819 A1
(43) Pub. Date: Oct. 7, 2021

(54) CHARGING DEVICE, PRINTER, AND CHARGING METHOD

(71) Applicant: TOSHIBA TEC KABUSHIKI KAISHA, Tokyo (JP)

(72) Inventor: Naoyuki HATTORI, Izunokuni Shizuoka (JP)

(21) Appl. No.: 17/190,366

(22) Filed: Mar. 2, 2021

(30) Foreign Application Priority Data
Apr. 1, 2020 (JP) 2020-066043

(51) Int. Cl. H02J 7/00; G06K 15/00

(52) U.S. Cl. CPC H02J 7/00712; G06K 15/4055; H02J 7/0047; H02J 7/0045

(57) ABSTRACT

A charging device includes a battery, a port to which a cable is connected to receive electric power, a charging circuit configured to charge the battery using the electric power supplied through the cable, and a controller configured to measure a voltage of the supplied electric power, and control the charging circuit to charge the battery by increasing a charging current to charge the battery one or more times until the measured voltage reaches a predetermined voltage.

### CROSS-REFERENCE TO RELATED APPLICATIONS

This application is based upon and claims the benefit of priority from Japanese Patent Application No. 2020-066043, filed on Apr. 1, 2020, the entire contents of which are incorporated herein by reference.

### FIELD

Embodiments described herein relate generally to a charging device, a printer, and a charging method used by the charging device.

### BACKGROUND

Conventionally, when a battery mounted in an electronic device is to be charged, the electronic device is connected to a power supply via a cable such as a cable conforming to the Universal Serial Bus (USB) standard. Since the current that can be supplied by a USB-type cable differs depending on which of the various USB standards is being used, it is necessary for the electronic device to identify the particular standard of the connected USB cable. However, this generally requires a dedicated integrated circuit (IC) for identifying the standard of the USB cable on the basis of the information received from or via the USB cable, and this requirement for a dedicated IC circuit or chip complicates the overall configuration of the apparatus.

### BRIEF DESCRIPTION OF THE DRAWINGS

FIG. 1 is an external view illustrating a power supply device and a charging device according to a first embodiment.

FIG. 2 is a block diagram showing a charging device according to a first embodiment.

FIG. 3 is a current value table showing settable charging currents according to a first embodiment.

FIG. 4 is a flowchart of a control process according to a first embodiment.

FIG. 5 is a table showing a relationship between a decrease amount of a Vbus voltage and an increase amount of a charging current according to a second embodiment.

FIG. 6 is a flowchart of a control process according to a second embodiment.

### DETAILED DESCRIPTION

In general, according to one embodiment, a charging device includes a battery, a port to which a cable is connected to receive electric power, a charging circuit configured to charge the battery using the electric power supplied through the cable, and a controller. The controller is configured to measure a voltage of the supplied electric power, and control the charging circuit to charge the battery by increasing a charging current to charge the battery one or more times until the measured voltage reaches a predetermined voltage.

Hereinafter, example embodiments will be described with reference to the drawings.

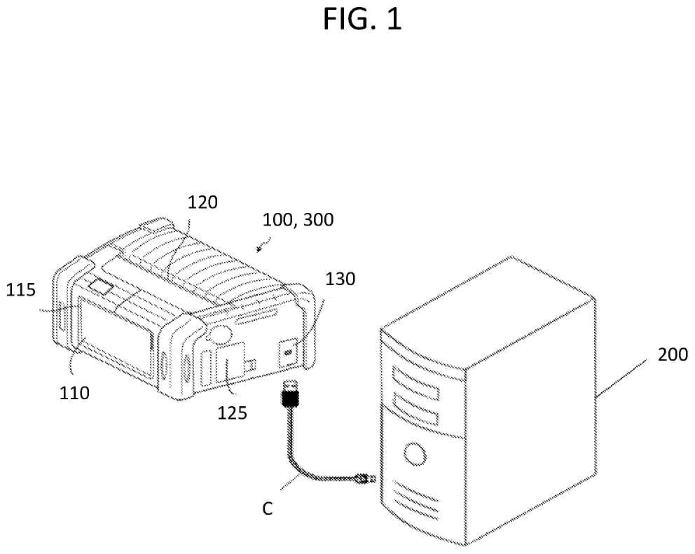

FIG. 1 is an external view showing a charging device and an external device. In this disclosure, a portable printer 100 (hereinafter simply referred to as a printer 100) will be described as an example of a charging device. As an example of the external device, a PC 200 will be used. In FIG. 1, the printer 100 and the PC 200 are connected by a USB cable C conforming to the USB standard. USB 2.0, USB 3.0, USB 3.1, or the like has been developed as the USB standard, and data transmission/reception and a charging speed vary depending on the standard.

The printer 100 includes an operation unit 110, a display unit 115, a printing unit 120, a battery 125, and a USB port 130.

The operation unit 110 includes, for example, various input keys for an operator to manually input data. The display unit 115 displays setting information and operation information. The display unit 115 has a liquid crystal screen or the like. The operation unit 110 and the display unit 115 may be integrated into a touch-enabled display.

The printing unit 120 includes a thermal head and a platen roller. For example, the thermal head has a plurality of heating elements and performs printing by heating a heat-sensitive sheet based on a printing command issued by a host computer. The heat-sensitive sheet is, for example, a receipt paper or a heat-sensitive label. The platen roller is rotationally driven by the controller 155 in synchronization with the printing operation. The printing unit 120 sandwiches a sheet to be printed with the thermal head and the platen roller, and performs printing with the thermal head while conveying the sheet with the platen roller.

The battery 125 stores electric power to be supplied to the printer 100. The battery 125 is a lithium ion battery, an alkaline storage battery, a lead storage battery, or the like.

The USB port 130 is an insertion port to which a USB device or a USB cable C can be connected. The printer 100 transmits and receives signals to and from the USB device or the USB cable C inserted into the USB port 130. When a USB cable C is inserted, the battery 125 can be charged with power supplied from the outside.

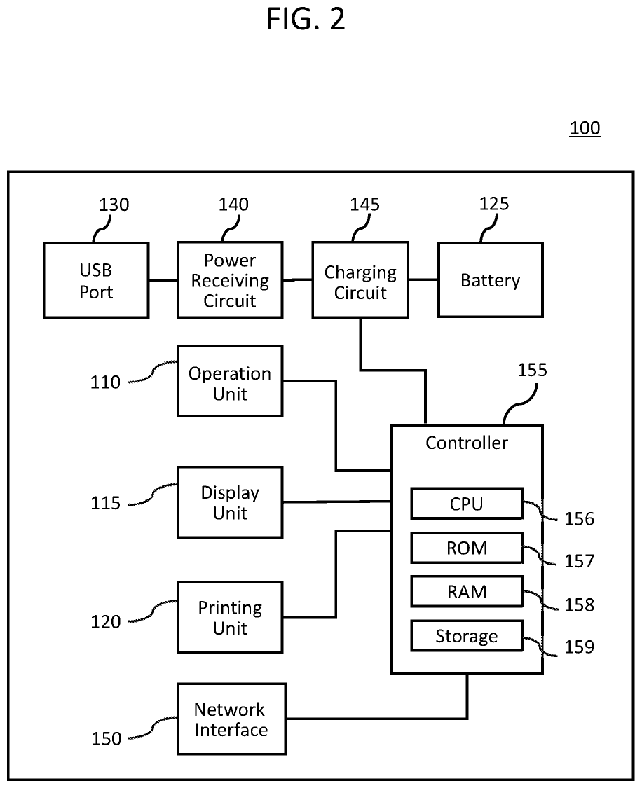

FIG. 2 is a circuit diagram of the printer 100 according to an embodiment. The printer 100 includes a USB port 130, a power receiving circuit 140, a charging circuit 145, the battery 125, the operation unit 110, the display unit 115, the printing unit 120, a network interface 150, and a controller 155. In the following description, the operation unit 110, the display unit 115, the printing unit 120, the battery 125, and the network interface 150 are collectively referred to as a load.

The power receiving circuit 140 receives and converts electric power supplied via the USB port 130 into a direct current suitable for each component of the printer 100, and supplies the direct current thereto. For example, the power receiving circuit 140 includes a rectification circuit that rectifies AC power supplied from the USB port 130 into DC power and a DC/DC converter that converts the voltage of the DC power to a particular voltage suitable to each component of the printer 100.

The charging circuit 145 generates a voltage and a current to charge the battery 125. Hereinafter, the current supplied from the charging circuit 145 to the battery 125 is referred to as a charging current.

The network interface 150 is an interface circuit that communicates with an external device by wireless signals such as radio waves or infrared rays or a communication technique such as load modulation of a carrier waves used for power transmission.

The controller 155 includes a CPU (Central Processing Unit) 156, a ROM (Read Only Memory) 157, a RAM (Random Access Memory) 158, a storage device 159, and the like. The ROM 157 stores various programs. The RAM 158 temporarily stores various types of information. The storage device 159 is a storage device that stores various programs and data. The CPU 156, the ROM 157, the RAM 158, and the storage device 159 are connected to each other via a data bus. The CPU 156, the ROM 157, and the RAM 158 make up the controller 155. That is, the controller 155 executes a control process to be described later by executing a control program(s) stored in the ROM 157 or the storage device 159 and loaded into the RAM 158. The controller 155 controls each unit of the printer 100 based on various control programs stored in the ROM 157. The controller 155 may set a current value of the charging current for the battery 125.

Table 1 shows the relationship between a Vbus voltage and the amount of charging current when charging is performed using a USB cable C1. The Vbus voltage is a voltage applied to a USB port such as the PC 200 that supplies power. The printer 100 can acquire the Vbus voltage by receiving data of the voltage value measured on the power supply side or by measuring the voltage by the power receiving circuit 140. In the following example, the current value of the charging current for USB cable C1 is greater than that of USB cable C2 (USB cable C1>USB cable C2).

TABLE 1

| | | | | | | | |
|---|---|---|---|---|---|---|---|
| Current value (A) | 0.5 | 1.0 | 1.5 | 2.0 | 2.5 | 3.0 | 3.3 |
| Voltage value (V) | 5.0 | 5.0 | 4.9 | 4.8 | 4.8 | 4.8 | 0.0 |

Table 2 shows the relationship between the Vbus voltage and the amount of charging current when charging is performed using a USB cable C2.

TABLE 2

| | | | | | |
|---|---|---|---|---|---|
| Current value (A) | 0.5 | 1.0 | 1.5 | 2.0 | 2.3 |
| Voltage value (V) | 5.1 | 5.0 | 4.9 | 4.8 | 0.0 |

As shown in Tables 1 and 2, the Vbus voltage gradually drops as the charging current increases. In addition, an overcharge protection circuit is assembled in the PC 200, and when a current equal to or more than the upper limit current value determined for each standard of the USB cables C is made to flow, a latch in the overcharge protection circuit is turned off, and the supply of the current from the PC 200 is stopped. As a result, the Vbus voltage drops sharply. In other words, the upper limit current value determined for each USB cable C is a current value at the time when the Vbus voltage applied to the USB cable C reaches the lower limit voltage value. The lower limit voltage value is defined by the standard, for example, 5 V−(5 V×5%)=4.75V.

As shown in Tables 1 and 2, the rate of voltage drop of the Vbus voltage tends to decrease as the amount of power that can be supplied by each USB cable C increases. In this example, since the amount of power that can be supplied by the USB cable C1 is larger than the amount of power that can be supplied by the USB cable C2, the voltage drop is more gradual when the USB cable C1 is used. In other words, the cable C1, which can supply a relatively large amount of electric power, can be charged with a larger current value than the USB cable C2.

In the following description, the Vbus voltage and the charging current at the start of charging are referred to as a first voltage value and a first charging current, respectively. A predetermined Vbus voltage set in advance has a second voltage value (<the first voltage value), and the charging current is set to a second current value (>the first current value). The second voltage is set, for example, on the basis of a voltage defined by the USB standard (for example, 5 V±5%). In the following example, it is assumed that the USB cables C1 and C2 to be charged in 5 V are used, and 4.8 V is stored in advance in the storage device 159 as the second voltage value. In addition, the current value just before the power supply is stopped by the overcharge protection circuit and the Vbus voltage rapidly drops is referred to as a third current value, and the Vbus voltage at that time (that is, the lower limit voltage) is referred to as a third voltage value. In the following description, it is assumed that the third voltage value is 4.75 V, and when the voltage drops beyond this value, the voltage rapidly drops to 0 V. The third current value varies depending on the standard of the USB cable.

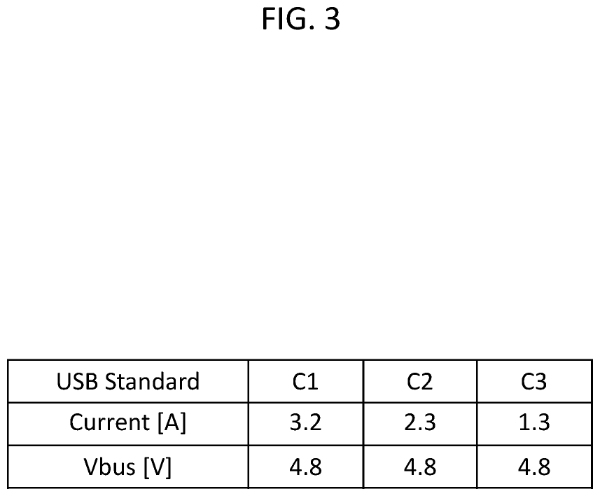

FIG. 3 is a current value table of the charging current that can be set by the charging circuit 145. The data of the current value table is stored in the storage device 159, for example. The current value table stores the upper limit value of the available charging current, which has been measured in advance for each standard of each USB cable C. In other words, the second current values and the second voltage values of the USB cables C of each standard are stored. In the current value table of FIG. 3, the standard of the USB cable C, the current value of the charging current and the value of the Vbus voltage are recorded, but any other parameters may be stored together.

Here, in a case where the USB cable C connected to the printer 100 is the USB cable C1, if a current value larger than 3.2 A is set as the charging current, the Vbus voltage may become lower than the lower limit of 4.75 V, and the overcharge protection circuit of the PC 200 may operate to stop charging.

Further, when the USB cable C connected to the printer 100 is the USB cable C2 if a current value larger than 2.3 A is set as the charging current, the Vbus voltage may become lower than the lower limit of 4.75 V, and the overcharge protection circuit of the PC 200 may to stop charging.

Further, when the USB cable C connected to the printer 100 is the USB cable C3 if a current value larger than 1.3 A is set as the charging current, the Vbus voltage may become lower than the lower limit of 4.75 V, and the overcharge protection circuit of the PC 200 may to stop charging.

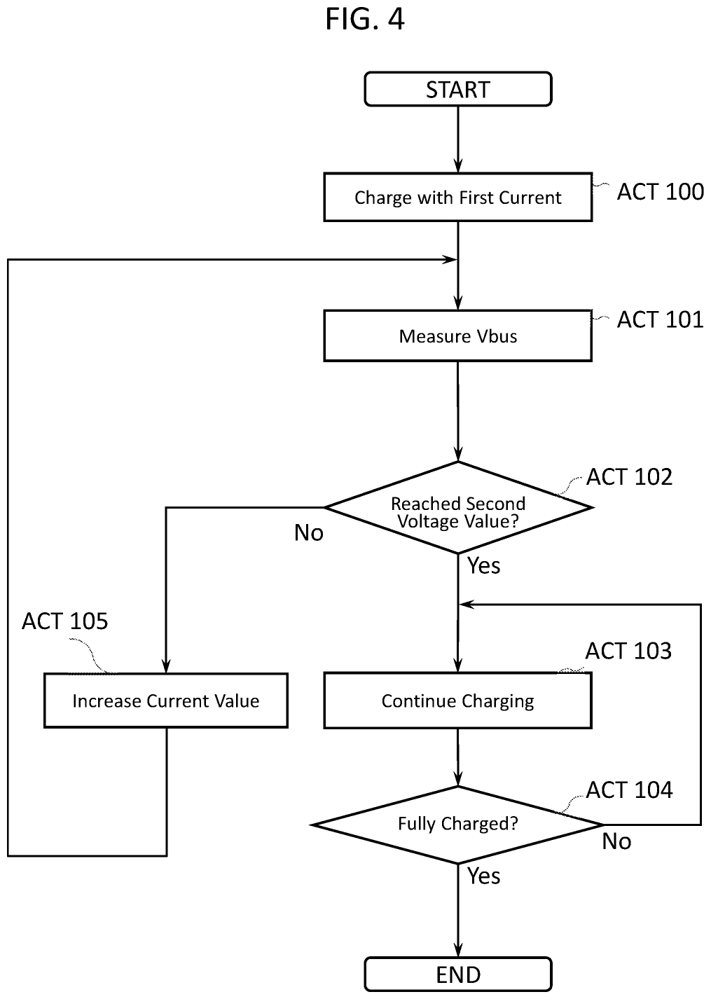

FIG. 4 is a flowchart illustrating a control process carried out by the controller 155. In the following example, the USB cable C2 (i.e., the second voltage value: 4.8 V, the second current value: 2.3 A) is used, but the printer 100 does not identify which USB cable C is connected.

When the USB cable C is connected to the USB port 130, the controller 155 controls the charging circuit 145 to set the charging current to the first current value and starts charging (ACT 100). This time, 1.3 A, which is the smallest current value among the current values stored in the current value table of FIG. 3, is used as the first current value. In this case, the overcurrent protection circuit of the PC 200 does not stop power supply regardless of which standard of the USB cable C connected to the printer 100.

The controller 155 measures the Vbus voltage (i.e., the first voltage value) applied to the power receiving circuit 140 (ACT 101). If the Vbus voltage applied to the power receiving circuit 140 has not reached the second voltage value (4.8 V in this example) (ACT 102, NO), the controller 155 changes the charging current to a charging current whose current value is one level higher in the current value table (ACT 105). In this example, the current value one level higher than 1.3 A is 2.3 A. Thereafter, the controller 155 returns the process toACT101.

In this example, since charging is performed using the USB cable C2, when the charging current is set to 2.3 A, the Vbus voltage reaches 4.8V. In ACT 102, since the Vbus voltage applied to the power receiving circuit 140 is the second voltage value (ACT 102, YES), the controller 155 sets the current value 2.3 A as the second current value and continues charging (ACT 103).

Thereafter, the controller 155 checks whether the battery 125 has been fully charged, and if not (ACT 105, NO), the process returns to ACT 103. When the battery 125 is fully charged (ACT105, YES), a series of charging processes is terminated.

Thus, even if the printer 100 is not equipped with a dedicated IC for identifying the standard of the connected USB cable C, the battery 125 can be charged by using a current value as large as possible without stopping charging by the overcurrent protection function.

### Second Embodiment

Next, a charging device 300 according to a second embodiment will be described. The charging device 300 is again a printer in this example, and will be referred to as printer 300. The printer 300 increases the charging current from a small value to a higher value and performs charging with current at the higher value when the Vbus voltage reaches the second voltage value. The increase in the amount of the charging current is determined according to the change in the Vbus voltage before and after the charging current is increased. The hardware configuration and the circuit configuration of the printer 300 of the second embodiment are the same as those of the printer 100 according to the first embodiment depicted in FIG. 1 and FIG. 2, for example.

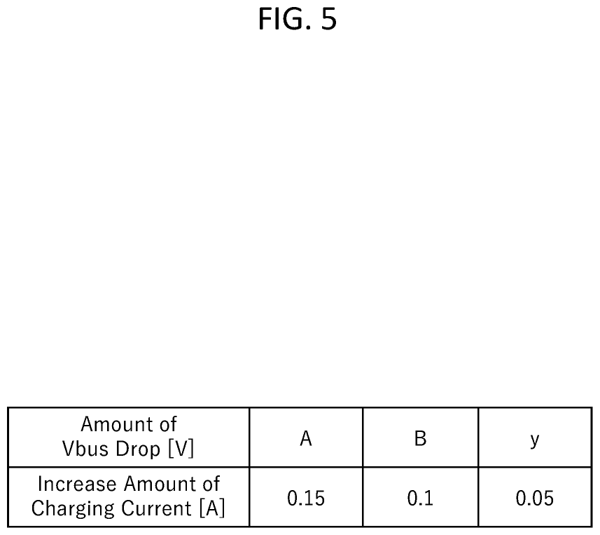

The storage device 159 of the printer 300 stores, for example, a table indicating the relationship between the change amount of the Vbus voltage and the increase amount of the charging current as illustrated in FIG. 5. Here, the change amount of each Vbus voltage satisfies a<b<y. That is, the larger the amount of change in the Vbus voltage before and after increasing the charging current is, the smaller the amount of increase in the charging current is. This makes it possible to increase the charging power as much as possible while preventing the Vbus voltage from falling below the third voltage value and the charging from being stopped.

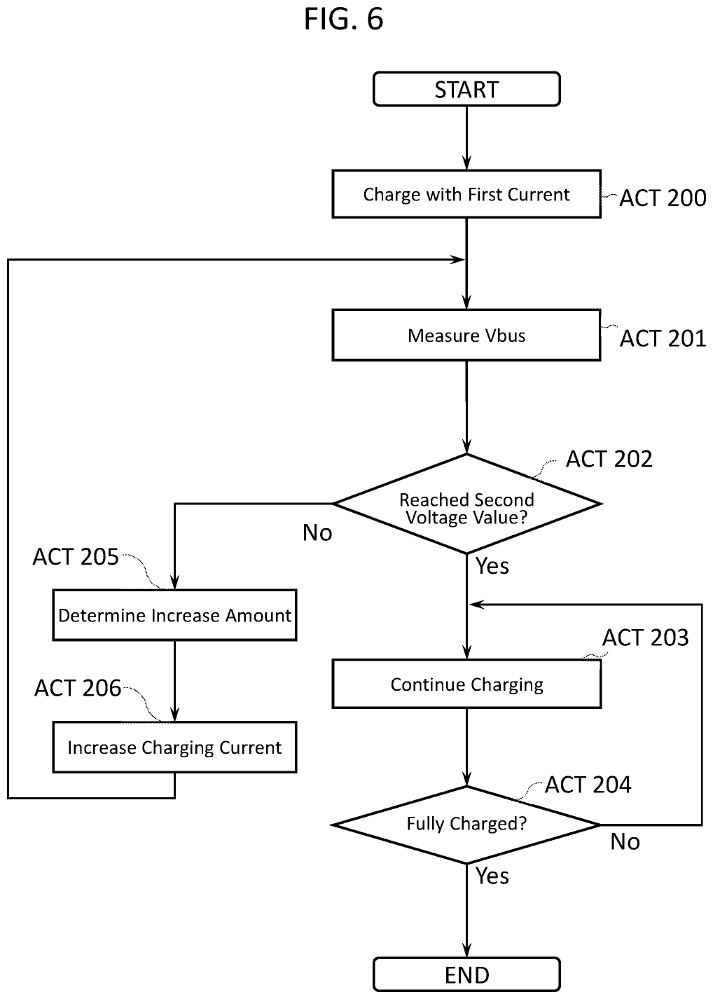

FIG. 6 is a flowchart illustrating a control process carried out by the controller 155. In the following example, the USB cable C2 (i.e., the second voltage value: 4.8V, second current value: 2.3 A) will be used, but the printer 300 does not identify which USB cable C is actually connected.

When the USB cable C is connected to the USB port 130, the controller 155 controls the charging circuit 145 to set the charging current to the first current value and starts charging (ACT 200). Here, charging is started with the first current value that has been set in advance (for example, 0.1 A).

The controller 155 measures the Vbus voltage applied to the power receiving circuit 140 (ACT 201). The measured voltage value of the Vbus voltage is temporarily stored in the storage device 159, for example. If the Vbus voltage applied to the power receiving circuit 140 has not reached the second voltage value (ACT 202, NO), the controller 155 determines an increase amount of the charging current (ACT 205). The increase amount is determined based on the table of FIG. 5. That is, the increase amount of the charging current is determined based on the difference between the Vbus voltage before the charging current is increased and the Vbus voltage after the charging current is increased. When the voltage value of the Vbus voltage before and after the increase of the charging current is not measured as at the start of charging, the Vbus voltage may be increased by a default value (for example, 0.1 A). Thereafter, the controller 155 increases the charging current by the first amount set in ACT 206 (ACT 206). Thereafter, the controller 155 returns the process to ACT 201.

The controller 155 repeats the process of ACT 201 through ACT 206 until the Vbus voltage applied to the power receiving circuit 140 reaches the second voltage value. In ACT 202, if the Vbus voltage has reached the second voltage value (ACT 202, YES), charging is continued with the charging current (second current value) at this time (ACT 203).

Thereafter, the controller 155 checks whether the battery 125 has been fully charged, and if not (ACT 204, NO), the process returns to ACT203. When the battery 125 has been fully charged (ACT 204, YES), the controller 155 ends the series of charging processes.

As a result, the printer 100 can charge the battery 125 with a current value as large as possible without stopping charging by the overcurrent protection function, without specifying the standard of the connected USB cable C and without having the current value table of the charging current as shown in FIG. 3.

In the above examples, the first current value is 0.1 A, but not limited to this. Any other current values may be set as the first current value. For example, the maximum current value that can be supplied by the USB cable C having the lowest power supply capability in the standard of the USB cable C (e.g., the USB cable C3 shown in FIG. 3) may be measured in advance, and charging may be started from the current value.

In the above examples, the increase amount of the charging current is set based on the change amount of the Vbus voltage. A fixed value (e.g., 0.1 A) may be used as the increment. For example, it is possible to prevent the Vbus voltage from exceeding the third voltage value by setting the increase amount to a relatively small value, e.g., 0.1 A. Alternatively, the time required for the charging current to reach the second current value can be shortened by setting a relatively large increase amount, e.g., 0.3 A.

In the above examples, a printer is used as an example of a charging device. However, the charging device may be any device capable of charging or recharging a battery by use of externally supplied power. Such a battery may be internal or external to the charging device and/or may be detachable from or fixed to or within the charging device. The battery may be attached to the charging device via one or more cables, wires, or connectors. In other examples, the charging device may be a smartphone, a tablet computer, a PC, or a battery charger. Furthermore, note that while the printer 100 and printer 300 are referred to in the present disclosure as a “charging device” each receives power from an external device (e.g., PC 200) via a USB-type connection. In some instances, printer 100, printer 300, and the like may be referred to as chargeable devices, rechargeable devices, battery-operated devices, battery-powered devices, portable devices, or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A charging device, comprising:
a battery;
a port to which a cable is connected to receive electric power;
a charging circuit configured to charge the battery using the electric power supplied through the cable; and
a controller configured to:
measure a voltage of the supplied electric power, and
control the charging circuit to charge the battery by increasing a charging current to charge the battery one or more times until the measured voltage reaches a predetermined voltage.

2. The charging device according to claim 1, further comprising:
a memory that stores a plurality of predetermined current values, wherein
the controller is further configured to choose one of the predetermined current values stored in the memory in ascending order.

3. The charging device according to claim 2, wherein each of the predetermined current values stored in the memory corresponds to a different standard to which the cable conforms.

4. The charging device according to claim 3, wherein each of the predetermined current values stored in the memory is a maximum value of a current that can be supplied by the cable according to the corresponding standard.

5. The charging device according to claim 1, wherein the controller is further configured to determine an amount of increase in the charging current based on a difference between voltages measured before and after the charging current has been previously increased.

6. The charging device according to claim 5, further comprising:
a memory that stores a plurality of amounts of decrease in the measured voltage each associated with a different amount of increase in the charging current, wherein
the controller is further configured to search the memory for an amount of increase in the charging current corresponding to the difference between the measured voltages.

7. The charging device according to claim 6, wherein a greater amount of decrease in the measured voltage is associate with a smaller amount of increase in the charging current.

8. The charging device according to claim 1, wherein the predetermined voltage is determined based on a standard to which the cable conforms.

9. The charging device according to claim 1, wherein the controller is further configured to receive data from an external device via the cable.

10. The charging device according to claim 9, wherein the data indicates a voltage of the supplied electric power.

11. A printer, comprising:
a printing unit;
a battery configured to supply electric power to drive the printing unit;
a port to which a cable is connected to receive electric power from an external device;
a charging circuit configured to charge the battery using the electric power supplied through the cable; and
a controller configured to:
measure a voltage of the supplied electric power, and
control the charging circuit to charge the battery by increasing a charging current to charge the battery one or more times until the measured voltage reaches a predetermined voltage.

12. The printer according to claim 11, further comprising:
a memory that stores a plurality of predetermined current values, wherein
the controller is further configured to choose one of the predetermined current values stored in the memory in ascending order.

13. The printer according to claim 12, wherein each of the predetermined current values stored in the memory corresponds to a different standard to which the cable conforms.

14. The printer according to claim 13, wherein each of the predetermined current values stored in the memory is a maximum value of a current that can be supplied by the cable according to the corresponding standard.

15. The printer according to claim 11, wherein the controller is further configured to determine an amount of increase in the charging current based on a difference between voltages measured before and after the charging current has been previously increased.

16. The printer according to claim 15, further comprising:
a memory that stores a plurality of amounts of decrease in the measured voltage each associated with a different amount of increase in the charging current, wherein
the controller is further configured to search the memory for an amount of increase in the charging current corresponding to the difference between the measured voltages.

17. The printer according to claim 16, wherein a greater amount of decrease in the measured voltage is associate with a smaller amount of increase in the charging current.

18. The printer according to claim 11, wherein the predetermined voltage is determined based on a standard to which the cable conforms.

19. The printer according to claim 11, wherein the controller is configured to receive data from an external device via the cable, and the data indicates a voltage of the supplied electric power.

20. A charging method for charging a device having a battery, the method comprising:
receiving electric power through a cable connected to a port of the device;
measuring a voltage of the supplied electric power; and
controlling a charging circuit of the device to charge the battery by increasing a charging current to charge the battery one or more times until the measured voltage reaches a predetermined voltage.
